(19) United States
(12) Patent Application Publication
(10) Pub. No.: US 2020/0033494 A1
(43) Pub. Date: Jan. 30, 2020

(54) THROUGH TUBING CEMENT EVALUATION USING SEISMIC METHODS

(71) Applicant: Baker Hughes, a GE company, LLC, Houston, TX (US)

(72) Inventors: Douglas J. Patterson, Magnolia, TX (US); Xiaochu Yao, Conroe, TX (US); Pawel J. Matuszyk, Spring, TX (US); Roger Steinsiek, Pearland, TX (US); Howard B. Glassman, Houston, TX (US)

(73) Assignee: Baker Hughes, a GE compnay, LLC, Houston, TX (US)

(21) Appl. No.: 16/523,559

(22) Filed: Jul. 26, 2019

Related U.S. Application Data
(60) Provisional application No. 62/711,395, filed on Jul. 27, 2018.

(51) Int. Cl. G01V 1/44; E21B 47/00; E21B 49/00

(52) U.S. Cl. CPC G01V 1/44; E21B 17/1021; E21B 49/00; E21B 47/0005

(57) ABSTRACT

Methods and apparatuses for evaluating an earth formation intersected by a borehole. Methods include estimating a property of cement surrounding a tubular in the earth formation by: generating an acoustic signal with a logging tool in the borehole; estimating the property in dependence upon a late reflected wave field of a modified response acoustic signal, wherein the modified response acoustic signal is produced by suppression of a direct mode component.

### FIELD OF THE DISCLOSURE

This disclosure generally relates to borehole tools, and in particular to methods and apparatuses for conducting well logging.

### BACKGROUND OF THE DISCLOSURE

Drilling wells for various purposes is well-known. Such wells may be drilled for geothermal purposes, to produce hydrocarbons (e.g., oil and gas), to produce water, and so on. Well depth may range from a few thousand feet to 25,000 feet or more. In hydrocarbon wells, downhole tools often incorporate various sensors, instruments and control devices in order to carry out any number of downhole operations. Thus, the tools may include sensors and/or electronics for formation evaluation, monitoring and controlling the tool itself, and so on.

Development of the formation to extract hydrocarbons may include installation of tubing (also referred to as tubular members or tubulars), such as production tubing or steel pipe known as casing, within a borehole, including the application of cement in the annulus between borehole and casing. It is known to conduct acoustic inspection of a casing cemented in a borehole to determine specific properties related to the casing and surrounding materials. For example, the bond between the cement and the casing may be evaluated, or the strength of the cement behind the casing or the casing thickness may be estimated, using measurements of reflected acoustic waves. This may be generally referred to as casing cement bond logging, which may be accomplished using a casing cement bond logging tool conveyed through the formation along the interior of the casing while taking measurements. In other examples of cement bond logging, a circumferential guided wave may be used to evaluate casing-related properties. For example, Lamb and shear wave attenuation measurements may be used to determine cement properties.

### SUMMARY OF THE DISCLOSURE

In aspects, the present disclosure is related to methods and apparatuses for evaluating an earth formation intersected by a borehole. Methods include estimating a property of cement surrounding a tubular in the earth formation by: generating an acoustic signal with a logging tool in the borehole; estimating the property in dependence upon a late reflected wave field of a modified response acoustic signal, wherein the modified response acoustic signal is produced by suppression of a direct mode component.

Methods may include receiving a response acoustic signal indicative of the property; and generating the modified signal by adjusting the response acoustic signal using seismic processing to suppress the direct mode component. Generating the acoustic signal may include generating a cement-centric acoustic signal by generating waveforms configured to suppress the direct mode component in a resulting modified response acoustic signal. Generating the acoustic signal may include estimating an optimal value for at least one excitation parameter for an acoustic excitation source to produce a guided wave of mixed multiple modes in a tubular. Generating the acoustic signal may include focusing the acoustic signal on the cement. Generating the acoustic signal may include generating a multi-tone acoustic beam. The tubular may be one of a plurality of nested tubulars. The plurality may include a second tubular closer to a tool in the borehole generating the acoustic signal than the tubular.

Methods as described above implicitly utilize at least one processor. Some embodiments include a non-transitory computer-readable medium product accessible to the processor and having instructions thereon that, when executed, causes the at least one processor to perform methods described above. Apparatus embodiments may include, in addition to specialized borehole measurement equipment and conveyance apparatus, at least one processor and a computer memory accessible to the at least one processor comprising a computer-readable medium having instructions thereon that, when executed, causes the at least one processor to perform methods described above.

Examples of some features of the disclosure may be summarized rather broadly herein in order that the detailed description thereof that follows may be better understood and in order that the contributions they represent to the art may be appreciated.

### BRIEF DESCRIPTION OF THE DRAWINGS

For a detailed understanding of the present disclosure, reference should be made to the following detailed description of the embodiments, taken in conjunction with the accompanying drawings, in which like elements have been given like numerals, wherein:

FIG. 1 illustrates an acoustic logging tool in accordance with embodiments of the present disclosure.

FIG. 2 shows an axial schematic view illustrating through tubing cement evaluation in accordance with embodiments of the present disclosure.

FIG. 3A shows a lateral schematic view illustrating a tool in accordance with embodiments of the present disclosure.

FIG. 3B shows a tool in accordance with embodiments of the present disclosure implemented with an integrated multiple-element transmitter array.

FIG. 4A illustrates a logging tool in accordance with embodiments of the present disclosure.

FIG. 4B illustrates another logging tool in accordance with embodiments of the present disclosure.

FIG. 5 shows a flow chart illustrating methods for inspecting an oilfield infrastructure component in accordance with embodiments of the present disclosure.

### DETAILED DESCRIPTION

Aspects of the present disclosure relate to apparatus and methods for well logging, including measurement and interpretation of physical phenomena indicative of parameters of interest related to installation of tubulars in the formation (e.g., properties of the cement which bonds casing to a formation). Embodiments described herein are particularly suited to multiple nested tubulars, such as, for example, tubulars of different diameters that are concentric to one another. Embodiments described herein are particularly suited to cement bond logging inspection.

The generation of acoustic signals and detection of reflections of these signals for single tubular is well known, and these reflections may be conventionally processed to estimate cement thickness, cement bond quality, and so on. Cement evaluation may be carried out based on the use of detected signal amplitude decay to assess casing thickness, cement density, and bond integrity.

Electromagnetic-acoustic transducers (EMATs) have been used in non-destructive testing, including in the borehole, using well-understood physical phenomena. In one type of EMAT, when a wire is placed near the surface of an electrically conducting object and is driven by a current at a suitable ultrasonic frequency, eddy currents are induced in a near surface region of the object. If a static magnetic field is also present, these eddy currents experience Lorentz forces. These forces cause an acoustic excitation in the object. In a reciprocal use, an electric signal will be generated in the wire as a result of acoustic excitation in a metal placed close to a permanent magnet. Attenuation and/or reflection of the acoustic waves bear information on the defects and surroundings of the object. See, for example, U.S. patent application Ser. No. 15/288,092 to Kouchmeshky et al, which is commonly owned and incorporated by reference herein in its entirety.

Guided wave attenuation cement bond logging (‘CBL’) measures wave attenuation along a casing circumferential direction. Multiple transmitters and receivers may be placed inside the casing for compensated attenuation measurements. See, for example, U.S. Pat. No. 7,660,197 to Barolak et al. and U.S. Pat. No. RE43,960 to Barolak et al, incorporated by reference herein in their entirety. The mechanical properties (e.g., Young's modulus, shear modulus) of the cement layer behind the casing determine the attenuation of the waves. An EMAT may be designed to produce a single waveform, such as shear horizontal waves (SH) or Lamb waves.

Cement evaluation in more than a single casing, however, becomes problematic to the point of being impractical. The present disclosure uses seismic methods to conduct cement bond evaluation by suppressing direct modes and looking at the late reflected wave field. Suppression may be achieved by using one or more transmitters along with multiple receivers to suppress tubing excitation and focus on the cement response. Additional transmitters may be employed for beam-steering acoustic energy to suppress direct modes. Compressional or shear sources could be used. Either of the source and the receiver(s) could be implemented as an EMAT, acoustic fluid coupled sensors, conventional transducers, and so on. An EMAT may offer enhancement by moving the source/receiver point into the tubing or first casing.

Various acoustic methodologies may be employed to transmit and receive acoustic signals, including guided wave, pitch-catch, pulse echo, and so on. Beam forming and other techniques may be used to focus the acoustic interaction within the cement. Various techniques for signal increase may also be leveraged, including dual resonance waves, mixing wave modes, estimating non-linear differences in signal, and the like.

Methods include performing cement bond evaluation for cement outside a second string (e.g., steel casing) behind (e.g., outside) a first string (e.g., tubing). The volume between the first and second string may be filled with fluid, which has relatively low impedance. This low impedance gap makes it challenging to recover signals sufficient to estimate the properties of the cement. Methods may employ an array of transmitter and receiver locations to suppress the first string interference and allow analysis of the ringing of the second casing string.

Further, filtering, modeling, and processing may be used to generate a modified acoustic signal to suppress the direct mode component in a resulting modified response acoustic signal. For example, analysis of the amplitude versus offset (AVO) may be utilized. Source-based, receiver-based, and processing mitigation as described herein may be used individually for streamlined or cost-efficient applications, or combined for greater effect.

Aspects of the disclosure may include estimating a property of cement surrounding a tubular in an earth formation. Estimating the property may be carried out by: generating an acoustic signal with a logging tool in the borehole, and estimating the property in dependence upon a late reflected wave field of a modified response acoustic signal, wherein the modified response acoustic signal is produced by suppression of a direct mode component. Generating the acoustic signal may include generating a cement-centric acoustic signal by generating waveforms configured to suppress the direct mode component in a resulting modified response acoustic signal.

Recently, techniques have been developed to use shear body waves to image fractures and features outside of the near borehole region (e.g., Deep Shear Wave Imaging). A “body wave” as used herein, refers to a wave that propagates through a medium rather than along an interface. These shear body waves may be created by a multipole acoustic tool, and are useful in far-field imaging. A region around a borehole can be described as including a near-field region and a far-field region. A near-field region includes the surface of a borehole and may extend laterally into the formation. The far-field region may extend tens of feet away from the borehole. Deep Shear Wave Imaging (‘DWSI’) signals can be propagated into the far-field region.

Aspects of the present disclosure relate to using at least one acoustic sensor as part of one or more downhole acoustic well logging tools or distributed sensor systems to produce acoustic information responsive to an acoustic wave from the earth formation. The sensor may include at least one acoustic transmitter configured and at least one acoustic receiver disposed on a carrier in the borehole, and configured to implement techniques of the present disclosure, as described in further detail below. A receiver and transmitter may be implemented as the same transducer, different transducers, or one or more transducer arrays. Transducers may be selected from the group consisting of: (i) electro-magnetic acoustic transducers (‘EMATs’), (ii) piezoelectric transducers, and (iii) wedge transducers. The information is indicative of a parameter of interest. The term “information” as used herein includes any form of information (analog, digital, EM, printed, etc.), and may include one or more of: raw data, processed data, and signals.

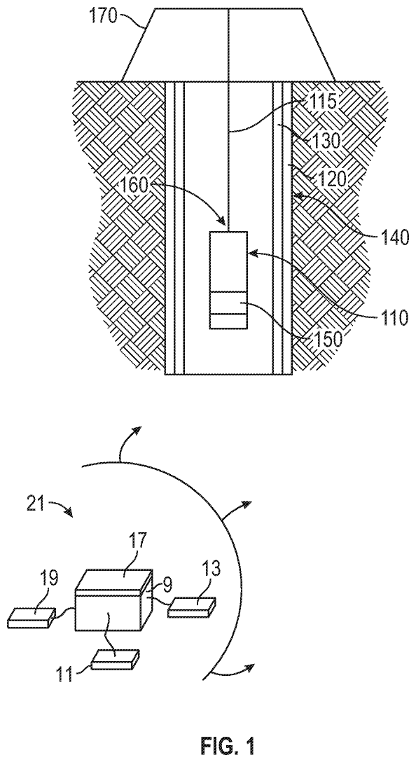

FIG. 1 illustrates an acoustic logging tool in accordance with embodiments of the present disclosure. The tool 110 is configured to be conveyed in a borehole intersecting a formation 180. The borehole wall 140 is lined with casing 130 filled with a downhole fluid 160, such as, for example, drilling fluid. Cement 120 fills the annulus between the borehole wall 140 and the casing 130. In one illustrative embodiment, the tool 110 may contain a sensor unit 150, comprising transmitters and receivers, which may include, for example, one or more EMATs, including a magnet array and at least one sensor coil (or other acoustic transducers), and configured for evaluation of the cement bond existing between the system of the casing 130, the borehole wall 140, and the cement 120 according to known techniques. Sensor unit 150 may include may include electronics configured to record and/or process the information obtained, or these electronics may be elsewhere on tool 110 or at the surface.

The system 101 may include a conventional derrick 170. A conveyance device (carrier 115) which may be rigid or non-rigid, may be configured to convey the downhole tool 110 into wellbore 140 in proximity to formation 180. The carrier 115 may be a wireline, coiled tubing, a slickline, an e-line, drill string, etc. Downhole tool 110 may be coupled or combined with additional tools. Thus, depending on the configuration, the tool 110 may be used during drilling and/or after the wellbore (borehole) 140 has been formed. While a land system is shown, the teachings of the present disclosure may also be utilized in offshore or subsea applications. The carrier 115 may include embedded conductors for power and/or data for providing signal and/or power communication between the surface and downhole equipment. The carrier 115 may include a bottom hole assembly, which may include a drilling motor for rotating a drill bit.

Certain embodiments of the present disclosure may be implemented with a hardware environment 21 that includes an information processor 17, an information storage medium 13, an input device 11, processor memory 9, and may include peripheral information storage medium 19. The hardware environment may be in the well, at the rig, or at a remote location. Moreover, the several components of the hardware environment may be distributed among those locations. The input device 11 may be any data reader or user input device, such as data card reader, keyboard, USB port, etc. The information storage medium 13 stores information provided by the detectors. Information storage medium 13 may include any non-transitory computer-readable medium for standard computer information storage, such as a USB drive, memory stick, hard disk, removable RAM, EPROMs, EAROMs, flash memories and optical disks or other commonly used memory storage system known to one of ordinary skill in the art including Internet based storage. Information storage medium 13 stores a program that when executed causes information processor 17 to execute the disclosed method. Information storage medium 13 may also store the formation information provided by the user, or the formation information may be stored in a peripheral information storage medium 19, which may be any standard computer information storage device, such as a USB drive, memory stick, hard disk, removable RAM, or other commonly used memory storage system known to one of ordinary skill in the art including Internet based storage. Information processor 17 may be any form of computer or mathematical processing hardware, including Internet based hardware. When the program is loaded from information storage medium 13 into processor memory 9 (e.g. computer RAM), the program, when executed, causes information processor 17 to retrieve detector information from either information storage medium 13 or peripheral information storage medium 19 and process the information to estimate a parameter of interest. Information processor 17 may be located on the surface or downhole.

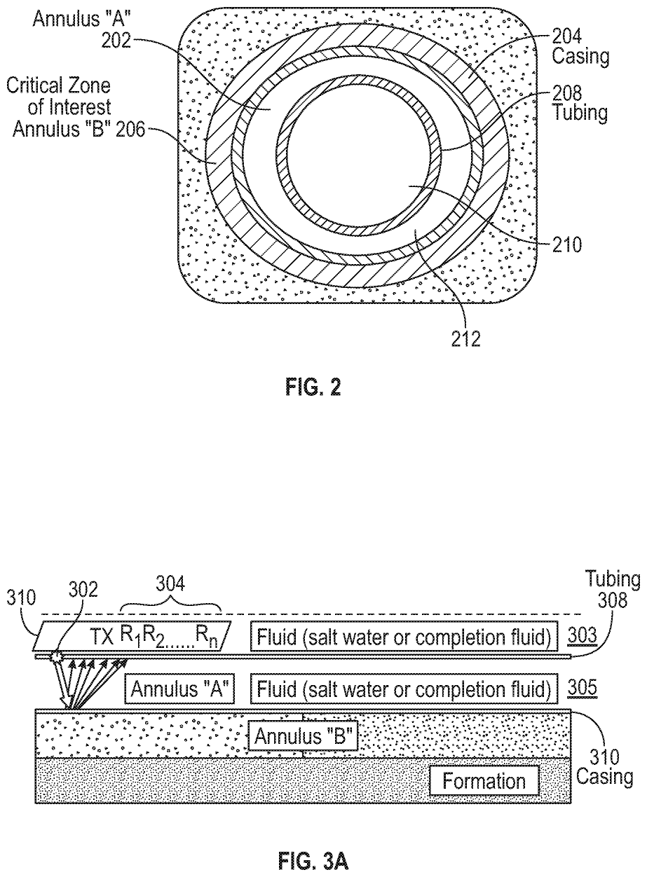

FIG. 2 shows an axial schematic view illustrating through tubing cement evaluation in accordance with embodiments of the present disclosure. Tubing 208 is located within casing 204 and is filled with fluid 210. Fluid 212 fills the annulus 202 between tubing 208 and casing 204. The fluid 210 and 212 may be completion fluid, salt water, and the like.

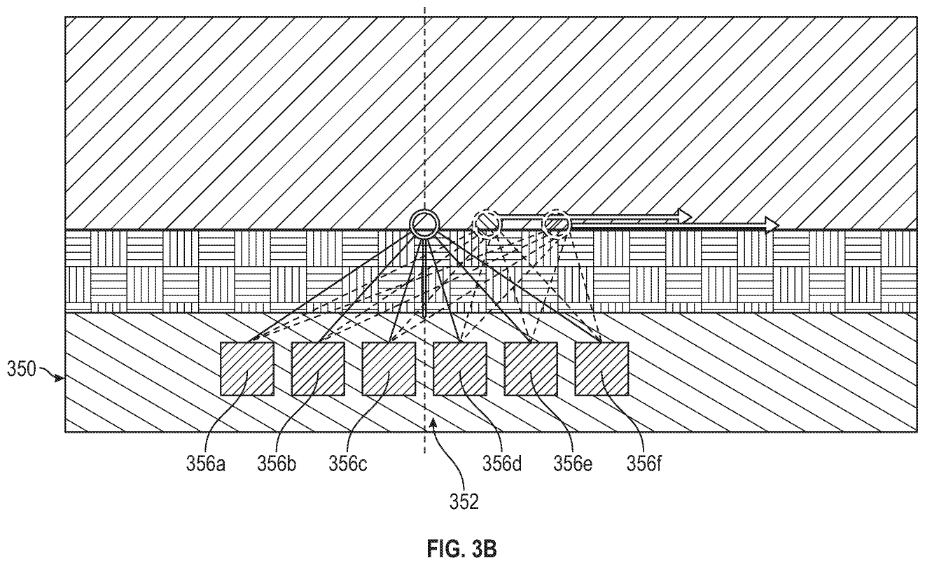

FIG. 3A shows a lateral schematic view illustrating a tool in accordance with embodiments of the present disclosure. Tool 310 comprises a transmitter 302 and a receiver array 304 comprising receivers R₁, R₂ . . . Rₙ. Tubing 308 is located within casing 310 and is filled with fluid 303. Fluid 305 fills the annulus A between tubing 308 and casing 310. The fluid 303 and 305 may be completion fluid, salt water, and the like. In some implementations transmitter 302 and receiver array 304 comprise EMATs. The use of multiple receivers allows suppression of tubing excitation and focus on the casing response. If a solid is present in annulus A, a shear source may be used.

Referring to FIG. 3B, the tool 350 may be implemented with an integrated multiple-element transmitter array 352. The array 352 may be configured with elements 356a-356f having a 9.0 mm element width, 1.0 mm kerf, and 12.5 mm standoff, operating at 100 kHz. The transducers may be implemented as multiple-layer stacked transducers. For example, an oil-filled four-layer stack of piezoceramic transducers may be used for a single transmitter of an array. The stack may have an absorber backing and a matching layer interfacing with the front facing, which may be, for example, inconel or other corrosion resistant material. In one example, the transducer stack may be driven in a range from 20 to 500 kHz.

The transducer front face material may have a slow-compressional velocity, e.g., close to that of the pad material if in a pad housing. A low compressional velocity in the pad and the fluid (e.g., slower than the formation shear velocity) will excite both compressional and shear refraction head waves. For acoustically slow formations (shear velocity less than fluid velocity), a shear head wave may not be excited, and only compressional head wave may be measured from the refraction method.

The pad material, if used as transducer front window, may have a compressional velocity less than or close to the fluid velocity in the borehole, or less than the shear velocity in the formation. Different sections of the pad may comprise different materials to correspond to the intended measurement. The pad material may provide protection as well as acoustic matching (e.g., impedance and/or quarter-wave matching) for maximum signal output. The pad thickness in close contact (or a fluid standoff gap) may be selected to allow ultrasonic beam to be fully developed to minimize near-filed interference. Acoustic damping in the pad material may also be desired to reduce direct tool mode and well-bore reflections. Use of reinforced plastic or rubber material may be implemented. Variable depth of focusing may be used to focus on a cement annulus to achieve optimum incident beams. The respective acoustic beams may have different firing frequencies for exciting formation p- and s head waves for each different penetration depth. A lateral beam steering sweep, or variable lateral steering, over a range of incident angles may be used. When used along with receiver signal detection, echo delay, and mode slowness calculation, this technique may allow optimum incident angles for maximum head wave sensitivity for a given volume, e.g., the cement-filled annulus.

Moreover, filtering, modeling, and processing of measurement data may be used to generate a modified acoustic signal to suppress the direct mode component in a resulting modified response acoustic signal. For example, analysis of the amplitude versus offset (AVO) may be utilized. After separating a response related to each tubular, the response attributable to the cement bonding the outer tubular may determined and properties estimated. In some cases, the near (“inner”) tubular response may be modeled first and then canceled from the acoustic signal. Modeling the near tubular response may be carried out using a priori data or data from additional sensors, such as, for example, nuclear or electromagnetic sensors.

Embodiments include performing an inversion of casing survey data of multiple downhole casing liners and completion installation components based on collocated three-dimensional low-frequency sinusoidal frequency domain waveform resistivity measurements and three-dimensional transient EM measurements taken with a multi-component induction tool. That is, a geometric structural description of casing multiple liners and borehole (ID & OD of each casing liner; eccentricity of each liner; shape of each liner; defects; etc.) may be derived from the combination of EM measurement information responsive to one or more pipe casings. Although the example of casing as the tubular is used throughout, the application of the techniques described herein is not so limited.

This geometrical structural description may then be used to interpret data from other measurements performed in the same surrounding media volume and depth location, and relating to the same casing structures. Joint evaluation may include one dimensional (1D), two dimensional (2D) or three dimensional (3D) imaging processing and/or forward-model based inversion, and so on, and may be complemented with information from other logging auxiliary measurements, such as, for example, for the generation of boundary conditions.

In one example, interpretation is carried out beginning with the innermost tubular and working outward. An interpretation sequence may include interpretation of survey measurements of a first (nearest) tubular based on magnetic flux measurements. The first tubular survey data interpretation may be employed to assist in the survey of the second closest tubular, and so on with other tubulars behind them. Subsequently, the low frequency sinusoidal frequency domain measurements may be carried out for each subsequent tubular in order from the lower diameter to largest diameter, followed by transient measurement data.

Acquisition of the late reflected wave field may be carried out by wave field separation and migration. In this way signals from the casing alone, or from other reflectors, may be isolated. For example, as described above, acoustic data may be obtained using a plurality of acoustic sensors, each at one of a plurality of spaced apart locations in a wellbore (e.g., on a tool), responsive to activation of a source. A spectrum of a wave field traveling in a first direction may be obtained by separating the wave field from a second wave field traveling in a second direction. Absorption may be modeled for the cement for at least one pair of the plurality of sensors by minimizing an objective function based on a relation between the spectra of the sensors. See also, U.S. Pat. No. 6,930,616 to Tang et al., hereby incorporated by reference in its entirety

Other embodiments may use full waveform inversion analogs to estimate properties of the bond. Full waveform inversion (‘FWI’) is a method of inverting acoustic data to infer earth subsurface properties that affect wave propagation. A forward modeling engine may use finite difference or other computational methods to model propagation of acoustic waves through the casing and cement. Accurate estimation of a source wavelet plays a crucial role in FWI. Geophysical applications to wavelet estimation have been extensively studied. Wavelet estimation may be carried out using direct arrivals or refracted waves, or conducted with surface-related multiple elimination. See Wang, Geophysics, Vol. 72. No. 2 (March-April 2007), Verschuur et al., Geophysics, Vol. 57. No. 9 (September 1992).

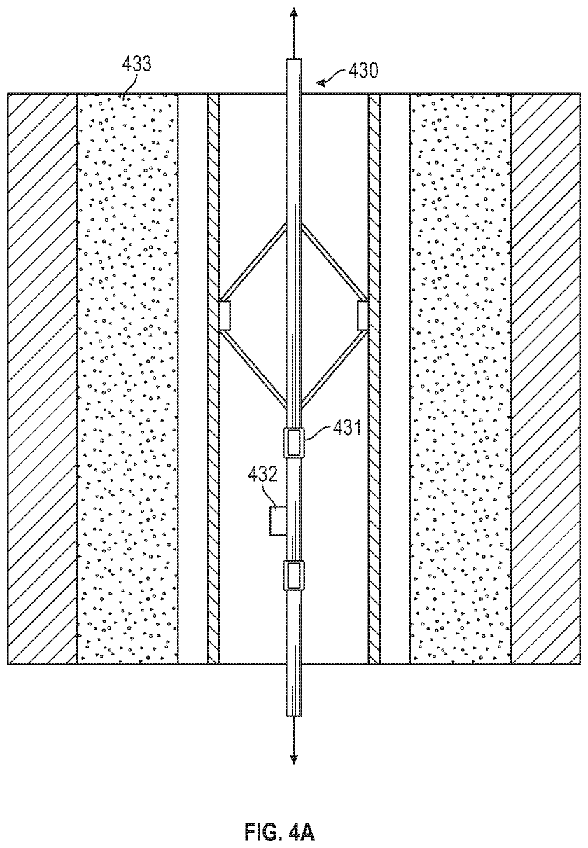

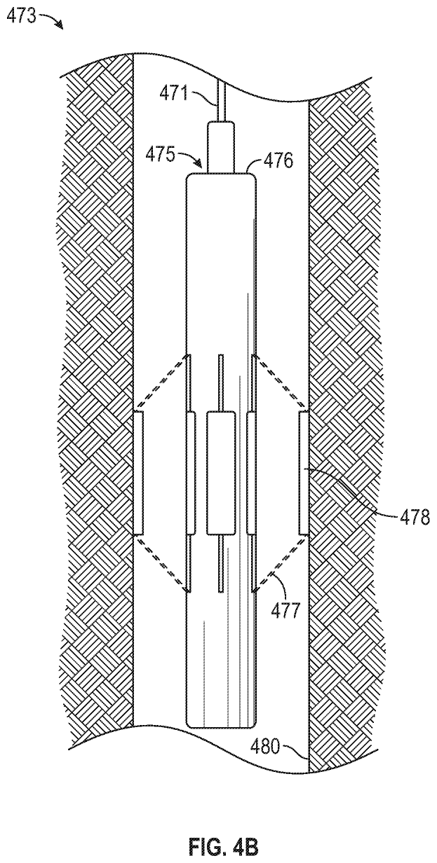

FIG. 4A illustrates a logging tool in accordance with embodiments of the present disclosure. The tool 430 may be connected with further downhole tools, above and/or below tool 430, such as perforation tools, stimulation tools, milling tools, rollers and so on, as part of a tool string. The tool 430 may be configured for conveyance in nested casing tubular 434a and 434b and configured to detect infrastructure features 433 exterior to the casing 434a and 434b. The tool 430 includes an acoustic beam transducer assembly 432 rotated by a motor section 431. A transient or multi-frequency EM 3D tool array 434 may reside between centralizer arms 436. The centralizer arms may urge a sensor array pad 437 against the inner wall of the innermost casing tubular. The sensor array pad 437 may include a magnetic flux detector and/or a pad-mounted acoustic beam transducer, as described in further detail below.

FIG. 4B illustrates another logging tool in accordance with embodiments of the present disclosure. The logging tool 474 has a number of extendable pads (e.g., from 4-6 pads or more) which. The tool 300 may be disposed on carrier 471 intersecting the earth formation 473. The tool 474 may include a body (e.g., BHA, housing, enclosure, drill string, wireline tool body) 476 having pads 478 extended on extension devices 477. Four pads are shown for illustrative purposes and, in actual practice, there may be more or fewer pads, such as two pads, three pads (e.g., separated by about 120 degrees circumferentially), or six pads (e.g., separated by about 60 degrees). The extension devices may be electrically operated, electromechanically operated, mechanically operated or hydraulically operated. With the extension devices fully extended, the pads may engage the wellbore 480 and make measurements indicative of at least one parameter of interest of the earth formation or wellbore infrastructure (e.g., casing). Such devices are well-known in the art. See, for example, U.S. Pat. No. 7,228,903 to Wang et al., and U.S. patent application Ser. No. 15/291,797, hereby incorporated by reference in their entirety.

Alternatively or additionally, generation of acoustic signals may be carried out by exciting mixed guided wave modes in the tubular. The multi-mode nature of these guided waves results in different modes having different wave velocities, attenuations, and amplitudes. If multiple modes are mixed together, the attenuation measurements may have very large errors. Usually, the attenuation response of a guided wave is derived from dispersion relations using a single frequency. However, this approach doesn't take the source excitation effect into account. The frequency-domain attenuation may be very different from the attenuation measurements of waveforms in the time domain.

Due to the multi-mode nature of guided waves, it is highly beneficial to optimize the excitation for a target volume (e.g., the cement annulus). Aspects of the disclosure may include estimating an optimal value for at least one excitation parameter for an acoustic excitation source to produce a guided wave of mixed multiple modes in the tubular. See U.S. patent application Ser. No. 15/809,779, “Guided Wave Attenuation Well Logging Excitation Optimizer Based on Waveform Modeling,” to Yao et al, incorporated herein by reference in its entirety. Guided wave attenuation responses determined directly from modeling waveforms with the influence of the excitation source are used to estimate cement properties.

Yao discloses systems, devices, products, and methods of well logging using a logging tool in a borehole in an earth formation. The volume may include at least one tubular, and the property may include the relation of multiple tubulars to one another, the relation of a tubular (e.g., casing) to another component, properties of bonding materials, adhesives, treatments, fluids, and the formation surrounding the casing, and so on. Aspects of the disclosure may be useful for the excitation of guided wave modes in tubular as part of any technique described herein.

The term “information” as used herein includes any form of information (analog, digital, EM, printed, etc.). As used herein, a processor is any information processing device that transmits, receives, manipulates, converts, calculates, modulates, transposes, carries, stores, or otherwise utilizes information. In several non-limiting aspects of the disclosure, an information processing device includes a computer that executes programmed instructions for performing various methods. These instructions may provide for equipment operation, control, data collection and analysis and other functions in addition to the functions described in this disclosure. The processor may execute instructions stored in computer memory accessible to the processor, or may employ logic implemented as field-programmable gate arrays (‘FPGAs’), application-specific integrated circuits (‘ASICs’), other combinatorial or sequential logic hardware, and so on.

In one embodiment, electronics associated with the transducers may be configured to take measurements as the tool moves along the longitudinal axis of the borehole (‘axially’) using sensor 150. These measurements may be substantially continuous, which may be defined as being repeated at very small increments of depth, such that the resulting information has sufficient scope and resolution to provide an image of tubular parameters (e.g., properties of the tubular or supporting infrastructure).

In other embodiments, all or a portion of the electronics may be located elsewhere (e.g., at the surface, or remotely). To perform the treatments during a single trip, the tool may use a high bandwidth transmission to transmit the information acquired by 150 to the surface for analysis. For instance, a communication line for transmitting the acquired information may be an optical fiber, a metal conductor, or any other suitable signal conducting medium. It should be appreciated that the use of a “high bandwidth” communication line may allow surface personnel to monitor and control operations in “near real-time.”

One point of novelty of the systems illustrated above is that the at least one processor may be configured to perform certain methods (discussed below) that are not in the prior art. A surface control system or downhole control system may be configured to control the tool described above and any incorporated sensors and to estimate a parameter of interest according to methods described herein.

In some general embodiments, at least one processor of the system (e.g., one or more of any of a surface processor, downhole processor, or remote processor) may be configured to use an acoustic monopole and/or multipole (e.g., dipole) transmitters to emit acoustic energy pulses that typically travel radially outwardly from the transmitters and to use at least one acoustic receiver to produce a corresponding signal, responsive to a reflection of an emitted wave. At least one of the processors may also be configured to evaluate the cement surrounding the tubular from the information corresponding to this signal. In operation, a portion of waves generated by the transmitter reflects from cement causing a response at the receiver. The waves generated by the transmitter are specifically configured to interact with the cement, such that the interaction has characteristics producing viable signal at the receiver. Thus, each receiver produces a response indicative of the cement. For example, frequency may be specifically chosen for the desired response.

For dipole configurations, a processor of the tool directs one or more dipole sources to transmit energy into the borehole and the formation. For example, the dipole source may transmit in a direction “x” extending away from the borehole, which is typically perpendicular or substantially perpendicular to the longitudinal axis of the borehole and the tool (the “z” direction). Flexural waves are generated that typically can reflect and provide readings out to around 2-4 feet radially into the formation (near field region). The maximum possible distance may be referred to as the near-field zone. Body waves, which can be reflected back to the borehole, may be detected as signals that are late-arriving and faint relative to reflected flexural wave signals. The region around the borehole can be divided into a near-field region that extends laterally (e.g., perpendicular to the borehole axis) to a first distance from the borehole, and a far-field region that extends laterally from the first distance to a second distance. The near-field region, as defined herein, may mean from the borehole to the furthest distance that flexural waves can extend and return detectable reflected signals.

The source may comprise a dipole source that generates two different types of shear body waves in the formation: a vertical shear wave (SV) aligned with the dipole source and polarized in the “x” direction, and a horizontal shear wave (SH) polarized in the “y” direction. The dipole source may operate at a frequency of 2-3 kHz. In embodiments, the source generates shear body waves that radiate toward the formation into the cement, and are reflected by a boundary between cement and tubular or cement and formation. The processing technique includes a direct wave mode that must be suppressed.

The processing techniques above can be used in conjunction with other techniques for acoustic evaluation, such as ultrasonic imaging, Stoneley analysis, and azimuthal shear-wave evaluation from cross-dipole, that typically investigate a limited area around a well, e.g., 2-4 ft. Ultrasonic acoustic tools provide better resolution due to their high directivity.

Unfortunately, at ultrasonic frequencies, acoustic signals cannot penetrate below the skin of the innermost tubular, in part because of the lower resonance frequency of the acoustic system represented by the multiple liner installation. Embodiments may also excite an acoustic wave approximating the resonances of different casing and cement layers, which enhance wave penetration.

Taking acoustic well logging measurements may be carried out by generating a rotating multi-tone acoustic beam from at least one transmitter on the tool, the beam comprising a high frequency signal modulated by a low frequency envelope, the high frequency signal including a first sub signal at a first frequency and a second sub signal at a second frequency; and generating measurement information at at least one acoustic receiver on the logging tool in response to a plurality of acoustic reflections of the acoustic beam from at least one volume of cement in the formation. An acoustic beam may be defined as an acoustic emission of limited aperture. The property of the volume is estimated from the measurement information.

The beam may be rotated, e.g., by rotating a stacked transducer through a plurality of azimuthal orientations. At least one of the first frequency and the second frequency may correspond to a resonant frequency of the at least one tubular. The high frequency signal may have a frequency greater than 350 kHz; the low frequency envelope may have a frequency less than 100 kHz. The multitone acoustic beam may have a lateral beam field of dimensions substantially the same as that of the high-frequency signal. As one example, acoustic waves corresponding to the generated multitone acoustic beam travel through multiple liners in the borehole hitting every interface, portions of which are reflected back and received by the at least one acoustic receiver.

Cement evaluation may rely on detection of resonance frequency and signal amplitude decays to assess bond integrity. A multiple tubular system, (e.g., double casings with different thicknesses) may have multiple resonance modes. The modes usually include modes corresponding to resonances from each casing, resonances from the composite system, and harmonic resonances. To maximize energy penetration and signal sensitivity, exciting casing resonance is often required. Selection of frequencies may be carried out in dependence upon these resonance modes.

Mathematical models, look-up tables, or other models representing relationships between the signals and the values of the formation properties may be used to characterize operations in the formation or the formation itself, optimize one or more operational parameters of a production or development, and so on. The system may carry out these actions through notifications, advice, and/or intelligent control.

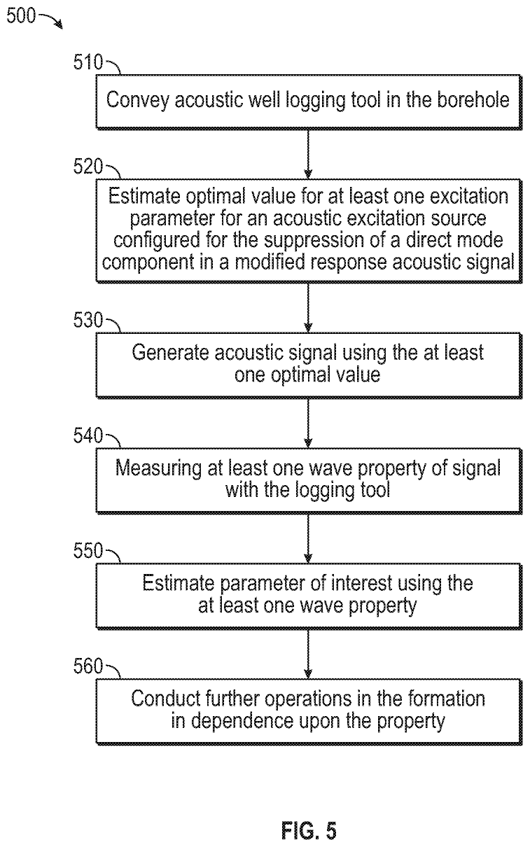

FIG. 5 shows a flow chart 500 illustrating methods for inspecting an oilfield infrastructure component in accordance with embodiments of the present disclosure. In optional step 510, an acoustic well logging tool is conveyed in tubing installed in the borehole.

Step 520 comprises estimating an optimal value for at least one excitation parameter for an acoustic excitation source configured for the suppression of a direct mode component in a modified response acoustic signal. The at least one excitation parameter may include at least frequency. This step may include selection of appropriate frequencies at each of one or more acoustic sources to enable or facilitate suppression of the direct mode through processing (such as seismic techniques). Alternatively, estimating the optimal value for at least one excitation parameter may include estimating a cement-centric acoustic signal. This may be accomplished by generating a predicted response from forward modeling of candidate parameters and selecting candidate parameters producing predicted responses suppressing the direct mode component in a resulting modified response acoustic signal. Estimating the excitation parameter may include estimating an optimal value for each of the at least one excitation parameter to produce a guided wave of mixed multiple modes in the tubular. For example, the optimal signal may produce a guided wave of mixed multiple modes in the tubular adjacent the cement to estimate cement properties from an acoustic signal responsive to the interaction of the guided wave with the cement.

Estimating the optimal value may be carried out by calculating a guided wave dispersion relation in a frequency domain for each of a plurality of simulated guided waves corresponding to a plurality of frequency values; modeling each of the plurality of simulated guided waves, wherein the modeling comprises generating a time domain waveform for each of a plurality of wave modes in dependence upon the acoustic excitation source; and using an excitation optimizer module for selecting the at least one excitation parameter corresponding to an optimal simulated guided wave determined in dependence upon the application of waveform criteria to the time domain waveforms. The simulated guided waves may correspond to a plurality of test values of the at least one excitation parameter.

Step 530 may include generating a guided wave in the component, such as, for example, tubular (e.g., casing) using the at least one optimal excitation parameter. Generating the acoustic signal may comprise focusing the acoustic signal on the cement, generating a multi-tone acoustic beam, or the like. The signal may be iteratively adjusted based on feedback from the signal to minimize direct mode contributions. Step 540 may include measuring at least one wave property of signal with the logging tool, such as, for example, amplitude, wave speed, group velocity of different modes, and so on.

Step 550, may include estimating a parameter of interest (e.g., a property) relating to installation of the casing using the at least one wave property. Estimating the property may be carried out based upon a late reflected wave field of the modified response acoustic signal. This modified response signal may be obtained by adjusting the response acoustic signal using seismic processing to suppress the direct mode component, as described above. The property may include one of i) a shear modulus of the cement; ii) a Young's modulus of the cement; iii) compressive stress; iv) thickness; v) cement density; vi) bond quality, and so on. Step 560 comprises conducting further operations in the formation in dependence upon the property. Method embodiments may include using the at least one processor to perform at least one of: i) storing the at least one property in a computer memory; ii) transmitting the at least one property uphole; or iii) displaying of the at least one property to an operating engineer.

A forward model response may be established for the applicable casing survey tool used to acquire the measurements, such as, for example, based on an ideal structure previously defined from a prior infrastructure knowledge. An inversion may be performed with the forward model response to establish borehole and casing geometry, thickness, and corrosion variations, cement density, and so on. Cement property estimation may be carried out by iterative solutions (e.g., waveform matching) inverting for enhanced cement properties such as cement density.

Optional steps may include modeling an attenuation-velocity response for each of the plurality of simulated guided waves, summing the estimated time domain waveforms to model each guided wave, and/or estimating a processing window for calculating acoustic wave information from characteristics of a time domain waveform for at least one of the plurality of wave modes. For example, attenuation may be modeled from a window amplitude ratio of the time domain waveform for at least two of the plurality of wave modes. Other characteristics may include velocity, arrival time, and other wave packet characteristics.

Methods may include detecting casing resonances via acoustic excitation using a frequency sweep or short-duration broad-band pulse from a broad-band transducer, e.g., a transducer attached to a casing wall. A transmitter may be used to acoustically excite the volume of interest, and the borehole infrastructure components therein, at a plurality of frequencies. The components may include, for example, a plurality of nested conductive tubulars in the borehole. A Fast Fourier Transform (FFT) spectrum of a returned signal at a receiver responsive to the excitation may be generated. The FFT spectrum is compared (e.g., correlated) with reference spectra determined from a range of known casing thicknesses and intermediate layers to identify a resonance frequency corresponding to each of one or more of the components. The resonance frequencies of each casing layer may be identified from modeled or measured reference spectra at known conditions. The results of FFT correlation between the FFT measured and template spectra, and those results of other FFT attributes (amplitude, phase, and group delay around resonance frequency) may be used to identify casing resonance of each casing layer and estimate excitation signals producing multi-resonance—that is, resonance in each of a plurality of tubulars or other cylindrical volumes under investigation.

The FFT spectrum may be determined from theoretical models or measured in a laboratory setting with known casing thicknesses and coupling materials behind each casing (i.e., well bonded inner and outer casings, well bonded inner casing and poorly bonded outer casings, liquid or gas behind the casing, and so on. Casing thickness is sensitive to its resonance frequency and thus may be estimated based on known correlations, as described above. Cement bond and material behind casing are sensitive to FFT amplitude at the resonance, as well as phase and group delay around the resonance. Thus, for example, a drift in resonance frequency may be used to detect a wall thickness change.

The above method using frequency sweep or short-pulse broad-band beam can help detect the resonance frequency for each casing layer. Use of the multi-tone acoustic beam described above, with narrow band bursts at the resonance frequency of the casing layer, may be used to maximize signal transmission into the casing layer. The correlation of the measured and template FFT spectra is advantageous over time-domain correlation, as it preserves the resonances of individual casings. The phase and group delay responses are also more sensitive to load material behind (and coupling behind) the casing.

Optional methods may include using the parameter of interest to estimate a characteristic of a formation. Estimation of the parameter may include the use of a model. In some embodiments, the model may include, but is not limited to, one or more of: (i) a mathematical equation, (ii) an algorithm, (iii) an deconvolution technique, and so on. Reference information accessible to the processor may also be used.

Method embodiments may include conducting further operations in the earth formation in dependence upon formation information, estimated properties of the reflector(s), or upon models created using ones of these. Further operations may include at least one of: i) geosteering; ii) drilling additional boreholes in the formation; iii) performing additional measurements on the casing and/or the formation; iv) estimating additional parameters of the casing and/or the formation; v) installing equipment in the borehole; vi) evaluating the formation; vii) optimizing present or future development in the formation or in a similar formation; viii) optimizing present or future exploration in the formation or in a similar formation; ix) drilling the borehole; and x) producing one or more hydrocarbons from the formation.

Estimated parameters of interest may be stored (recorded) as information or visually depicted on a display (e.g., for an operating engineer). The parameters of interest may be transmitted before or after storage or display. For example, information may be transmitted to other downhole components or to the surface for storage, display, or further processing. Aspects of the present disclosure relate to modeling a volume of an earth formation using the estimated parameter of interest, such as, for example, by associating estimated parameter values with portions of the volume of interest to which they correspond, or by representing the boundary and the formation in a global coordinate system. The model of the earth formation generated and maintained in aspects of the disclosure may be implemented as a representation of the earth formation stored as information. The information (e.g., data) may also be transmitted, stored on a non-transitory machine-readable medium, and/or rendered (e.g., visually depicted) on a display.

The processing of the measurements by a processor may occur at the tool, the surface, or at a remote location. The data acquisition may be controlled at least in part by the electronics. Implicit in the control and processing of the data is the use of a computer program on a suitable non-transitory machine readable medium that enables the processors to perform the control and processing. The non-transitory machine readable medium may include ROMs, EPROMs, EEPROMs, flash memories and optical disks. The term processor is intended to include devices such as a field programmable gate array (FPGA).

The term “conveyance device” as used above means any device, device component, combination of devices, media and/or member that may be used to convey, house, support or otherwise facilitate the use of another device, device component, combination of devices, media and/or member. Exemplary non-limiting conveyance devices include drill strings of the coiled tube type, of the jointed pipe type and any combination or portion thereof. Other conveyance device examples include casing pipes, wirelines, wire line sondes, slickline sondes, drop shots, downhole subs, BHA's, drill string inserts, modules, internal housings and substrate portions thereof, self-propelled tractors. As used above, the term “sub” refers to any structure that is configured to partially enclose, completely enclose, house, or support a device. The term “information” as used above includes any form of information (Analog, digital, EM, printed, etc.). The term “processor” or “information processing device” herein includes, but is not limited to, any device that transmits, receives, manipulates, converts, calculates, modulates, transposes, carries, stores or otherwise utilizes information. An information processing device may include a microprocessor, resident memory, and peripherals for executing programmed instructions. The processor may execute instructions stored in computer memory accessible to the processor, or may employ logic implemented as field-programmable gate arrays (‘FPGAs’), application-specific integrated circuits (‘ASICs’), other combinatorial or sequential logic hardware, and so on. Thus, a processor may be configured to perform one or more methods as described herein, and configuration of the processor may include operative connection with resident memory and peripherals for executing programmed instructions.

The term “cement” as used herein refers to an engineered bonding material, such as concrete, configured for application to bond a tubular to the formation or another structure, and should not be confused with natural fracture fill cements. Such cements are naturally occurring and often associated with a fracture fluid event and occur as early diagenetic/precipitated cements that are associated with the original fluid composition of the fluid system stress event. Depending upon the fluid chemistry of the fluid event within a specific sedimentary unit (e.g., carbonate, siliclastic), these fracture fills can be simple mineral cement fill types such as calcite.

In some embodiments, estimation of the parameter of interest may involve applying a model. The model may include, but is not limited to, (i) a mathematical equation, (ii) an algorithm, (iii) a database of associated parameters, or a combination thereof.

Control of components of apparatus and systems described herein may be carried out using one or more models as described above. For example, at least one processor may be configured to modify operations i) autonomously upon triggering conditions, ii) in response to operator commands, or iii) combinations of these. Such modifications may include changing drilling parameters, steering the drill bit (e.g., geosteering), changing a mud program, optimizing measurements, and so on. Control of these devices, and of the various processes of the drilling system generally, may be carried out in a completely automated fashion or through interaction with personnel via notifications, graphical representations, user interfaces and the like. Reference information accessible to the processor may also be used.

The processing of the measurements made in wireline or MWD applications may be done by a surface processor, by a downhole processor, or at a remote location. The data acquisition may be controlled at least in part by the downhole electronics. Implicit in the control and processing of the data is the use of a computer program on a suitable non-transitory machine readable medium that enables the processors to perform the control and processing. The non-transitory machine readable medium may include ROMs, EPROMs, EEPROMs, flash memories and optical disks. The term processor is intended to include devices such as a field programmable gate array (FPGA).

A late reflected wave field may be defined as a reflected wave field with an arrival substantially following a predominant wave field. For example, flexural waves are generated that typically can reflect and provide readings out to around 2-4 feet into the formation. Waves that are radiated away from the borehole and travel farther into the formation are referred to as body waves, which can be reflected back to the borehole and are detected as signals that are late-arriving and faint relative to the reflected flexural wave signals.

While the foregoing disclosure is directed to the one mode embodiments of the disclosure, various modifications will be apparent to those skilled in the art. It is intended that all variations be embraced by the foregoing disclosure.

What is claimed is:

1. A method of evaluating an earth formation intersected by a borehole, comprising:
estimating a property of cement surrounding a tubular in the earth formation by:
generating an acoustic signal with a logging tool in the borehole;
estimating the property in dependence upon a late reflected wave field of a modified response acoustic signal, wherein the modified response acoustic signal is produced by suppression of a direct mode component.

2. The method of claim 1 comprising:
receiving a response acoustic signal indicative of the property; and
generating the modified response acoustic signal by adjusting the response acoustic signal using seismic processing to suppress the direct mode component.

3. The method of claim 1 wherein generating the acoustic signal comprises generating a cement-centric acoustic signal by generating waveforms configured to suppress the direct mode component in a resulting modified response acoustic signal.

4. The method of claim 3 wherein generating the acoustic signal comprises estimating an optimal value for at least one excitation parameter for an acoustic excitation source to produce a guided wave of mixed multiple modes in a tubular.

5. The method of claim 1 wherein generating the acoustic signal comprises focusing the acoustic signal on the cement.

6. The method of claim 1 wherein generating the acoustic signal comprises generating a multi-tone acoustic beam.

7. The method of claim 4 wherein the tubular is one of a plurality of nested tubulars.

8. The method of claim 7 wherein the plurality comprises a second tubular closer to a tool in the borehole generating the acoustic signal than the tubular.
